(19) United States
(12) Patent Application Publication
(10) Pub. No.: US 2005/0168053 A1
(43) Pub. Date: Aug. 4, 2005

(54) Insulating sleeve insert for wheel cladding

(76) Inventor: Gregory R. Hauler, Montague, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/757,335

(22) Filed: Jan. 14, 2004

(51) Int. Cl. B60B 7/00

(52) U.S. Cl. 301/37.105

(57) ABSTRACT

A wheel cover assembly comprises a wheel clad assembly that includes a body member having an outer surface and an inner surface opposed across the body member from the outer surface, and at least one elongated tubularly-shaped extension comprising a first material and having an inner surface, a proximal portion connected to the body portion, a distal portion extending in a direction away from the inner surface of the body portion, and at least one irregularity spaced along a length of the distal portion of the at least one extension. The wheel cover assembly further includes at least one tubularly-shaped insulating sleeve comprising a second material different from the first material and having an outer surface that abuts the inner surface of the at least one extension and includes an edge portion that closely receives the irregularity of the distal portion of the at least one extension therein, thereby preventing removal of the at least one sleeve from within the at least one extension in an axial direction. The edge portion is adapted to engage a wheel, thereby assembling the wheel cover assembly with the vehicle wheel. The sleeve is adapted to thermally insulate the wheel clad assembly from the vehicle wheel.

### BACKGROUND OF THE INVENTION

The present invention relates to a wheel cover assembly, and in particular to a sleeve connector for connecting a wheel clad assembly to a vehicle wheel and thermally insulating the wheel clad assembly therefrom.

Ornamental outer coverings have been employed for providing a decorative surface to the exposed surface of a vehicle wheel for many years. These outer coverings offer design flexibility and various configurations that may be used to cover a single style wheel. In certain applications, the ornamental wheel covering is constructed of a polymeric material or plastic that is then coated with a metal plating. U.S. Pat. Nos. 5,564,791; 5,577,809; 5,597,213; 5,630,654; 5,636,906; 5,845,973; and 6,085,829, the disclosures of which are incorporated herein by reference, represent different approaches for providing and attaching such claddings to existing wheels to provide a decorative appearing wheel.

Heretofore, wheel coverings have been assembled with the associated vehicle wheel by a variety of clips and/or fasteners having a configuration such that the cover member or wheel clad is in direct contact with at least a portion of the vehicle wheel, and/or a configuration wherein a significant amount of heat generated within the vehicle wheel due to braking and the like is transferred from the fastener to the attached wheel cladding. The heat received by the wheel may result in heat fatigue, thereby reducing the useful life of the wheel clad, as well as distortion and degradation to the aesthetic outer covering associated therewith.

Therefore, there is a current need for a connecting apparatus that insulates the wheel cover or cladding from heat being transferred between the vehicle wheel and the wheel cladding, while simultaneously providing a secure connection between the vehicle wheel and the wheel cover.

### SUMMARY OF THE INVENTION

One aspect of the present invention is to provide a wheel cover assembly that comprises a wheel clad assembly including a body member having an outer surface and an inner surface opposed across the body member from the outer surface, and at least one elongated tubularly-shaped extension comprising a first material and having an inner surface, a proximal portion connected to the body portion, a distal portion extending in a direction away from the inner surface of the body member, and at least one irregularity spaced along a length of the distal portion of the at least one extension. The wheel cover also includes at least one tubularly-shaped insulating sleeve comprising a second material different from the first material and having an outer surface that abuts an inner surface of the at least one extension and includes an edge portion that closely receives the irregularity of the distal portion of the least one extension therein, thereby preventing removal of the at least one sleeve from within the at least one extension in an axial direction. The edge portion is adapted to engage a vehicle wheel, thereby assembling the wheel cover assembly with the vehicle wheel, while the sleeve is adapted to thermally insulate the wheel clad assembly from the vehicle wheel.

Another aspect of the present invention is to provide a sleeve connector for connecting a wheel cover assembly to a vehicle wheel that includes a tubularly-shaped body portion, and an outer surface adapted to abut an inner surface of a tubularly-shaped extension of a wheel covering. The sleeve connector also includes a plurality of longitudinally-extending flexibly resilient fingers, wherein each finger includes an edge portion adapted to closely receive an irregularity located along a length of the extension of the wheel covering, thereby preventing removal of the sleeve from within the at least one extension in an axial direction. The edge portion of each finger is adapted to engage a vehicle wheel, thereby assembling the wheel covering with the vehicle wheel. The sleeve is adapted to thermally insulate the wheel covering from the vehicle wheel.

The present inventive wheel cover assembly provides a more durable and heat resistant wheel covering that may be operated/installed by even unskilled personnel, can be easily and quickly assembled, is economical to manufacture, capable of a long operating life while installed on an associated vehicle wheel, and is particularly well adapted for the proposed use.

These and other advantages of the present invention will be further understood and appreciated by those skilled in the art by reference to the following written specification, claims and appended drawings.

### BRIEF DESCRIPTION OF THE DRAWINGS

FIG. 1 is a perspective view of a wheel assembly;

FIG. 2 is an exploded perspective view of the wheel assembly that includes a plurality of sleeve connectors embodying the present invention;

FIG. 3 is a perspective view of a wheel cover assembly;

FIG. 4A is an enlarged perspective view of the sleeve connector located within an extension of a body member of a wheel clad assembly;

FIG. 4B is an enlarged, exploded perspective view of the sleeve connector and the associated extension of the body member;

FIG. 5 is a cross-sectional side view of the body member and a locking ring; and

FIG. 6 is a cross-sectional side view of the sleeve as received within the extension, and the sleeve assembled with a wheel of the wheel assembly.

### DETAILED DESCRIPTION OF THE PREFERRED EMBODIMENTS

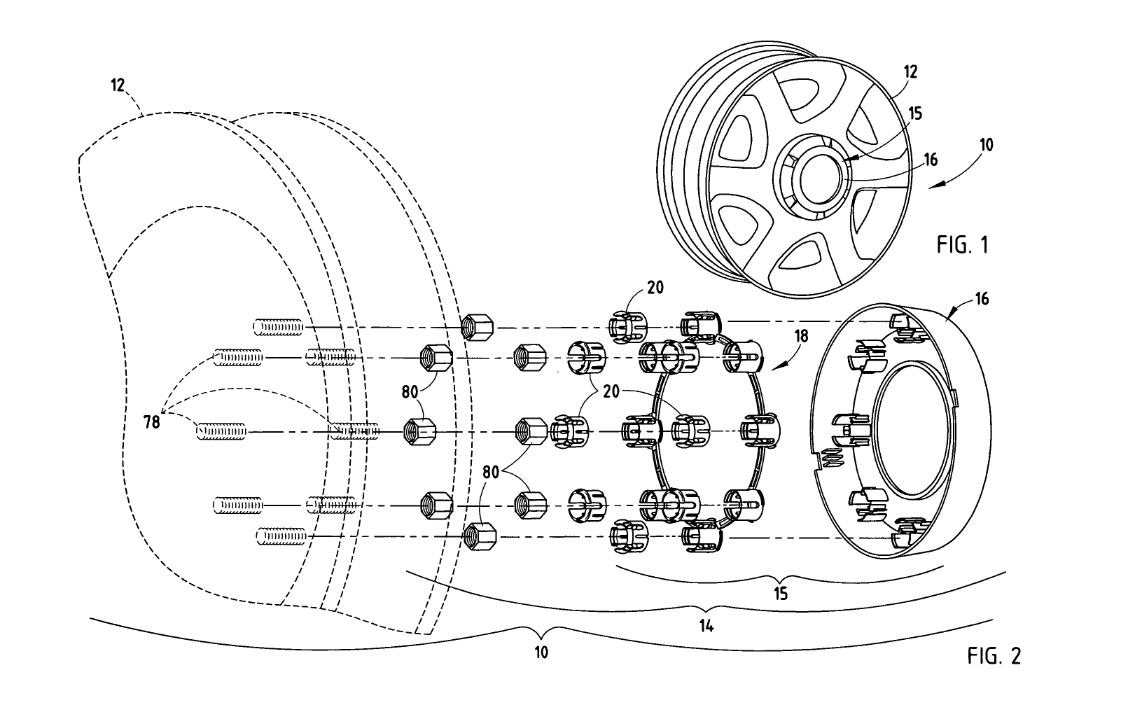

For purposes of description herein, the terms “upper,” “lower,” “right,” “left,” “rear,” “front,” “vertical,” “horizontal,” and derivatives thereof shall relate to the invention as oriented in FIGS. 1 and 2. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

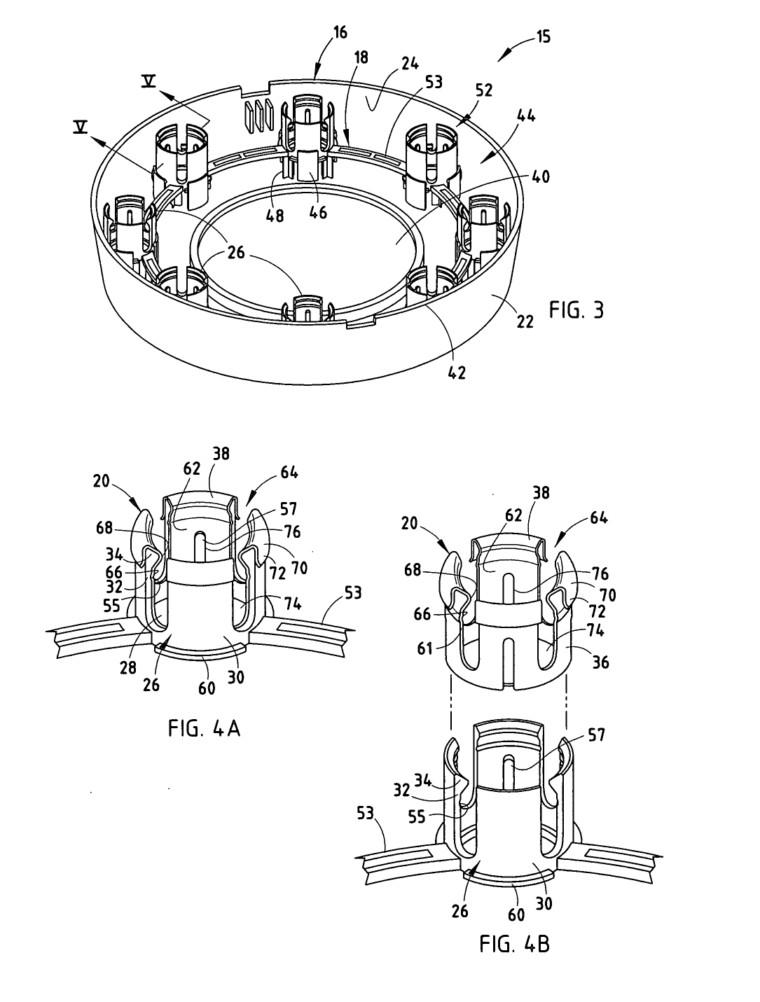

The reference numeral 10 (FIG. 1) generally designates a wheel assembly that includes a vehicle wheel 12 and a wheel cover assembly 14. The wheel cover assembly 14 comprises a wheel clad assembly 15 including a cover or body member 16, a locking ring 18 and a plurality of tubularly-shaped insulating sleeves 20. In the illustrated example, the body member 16 (FIG. 3) is substantially bowl-shaped and includes an outer surface 22 and an inner surface 24 opposed across the body member 16 from the outer surface 22. The locking ring 18 includes a plurality of tubularly-shaped extensions 26 each having an inner surface 28 (FIGS. 4A and 4B), a proximal portion 30 connected to the body member 16, and a distal portion 32 extending in a direction away from the inner surface 24 of the body member 16. The extension also includes a rib or tab 34 extending circumferentially about each extension 26. Each sleeve 20 includes an outer surface 36 that abuts the inner surface 28 of each associated extension 26. Each sleeve 20 also includes an edge portion 38 that closely receives the rib 34 of the distal portion 32 of each associated extension 26 therein, thereby preventing removal of the sleeve 20 from within the associated extension 26 in an axial direction. In assembly, the edge portion 38 of each sleeve 20 is adapted to engage the vehicle wheel 12, thereby assembling the wheel cover assembly 14 with the vehicle wheel 12, as described below. Each extension 26 of the locking ring 18 is constructed of a first material, such as a polymeric material, while each sleeve 20 is constructed of a second material that differs from the first material, such as stainless steel, as described below. In operation, the sleeves 20 are adapted to thermally insulate the wheel clad assembly 15 from heat within the vehicle wheel 12 generated during operation of the associated vehicle.

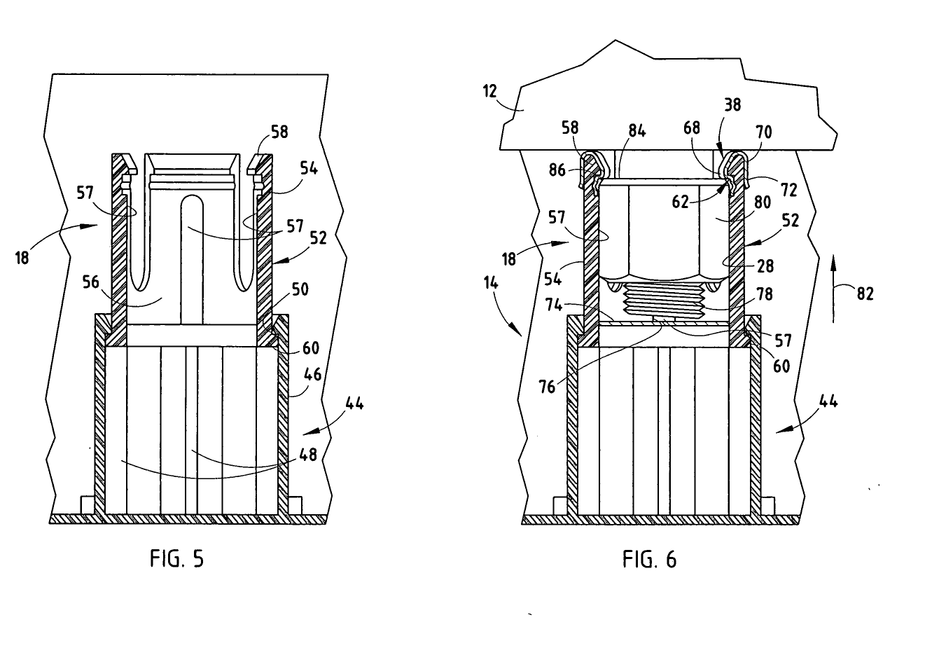

The cover member 16 and the locking ring 18 (FIGS. 3 and 5) of the wheel clad assembly 15 are typically constructed of similar materials, however, a different material may be used for the construction of each of these components. Specifically, the cover member 16 and the locking ring 18 are typically constructed of a polymeric-type material, while the cover member 16 is coated with a metallic-like covering. In the illustrated example, the cover member 16 is substantially bowl-shaped having an end wall 40 and an inwardly turned sidewall 42. A plurality of locking arrangements 44 extend inwardly from the inner 24 of the end wall 40, and include a plurality of flexibly resilient locking fingers 46 and a plurality of alignment fingers 48. Each locking finger is provided with a tab 50 located at a distal end thereof.

The locking ring 18 includes a plurality of tubularly-shaped extensions 52 each comprising a plurality of longitudinally-extending flexibly resilient fingers 54 extending outwardly from a cylindrically-shaped body portion 56. The extensions 52 are connected via a plurality of arcuately-shaped runners 53 extending therebetween. Each finger 54 includes one of the tabs 58 located at a distal end thereof, and a tab 57 extending inwardly from the inner surface 28. A plurality of locking tabs 60 are spaced circumferentially about a lower portion of each body portion 56 and are spaced so as to align with the locking fingers 46 of the cover member 16, as described below.

Each sleeve 20 includes a distal portion 61 divided longitudinally into a plurality of flexibly resilient fingers 62 spaced by gaps 64. The end portion 38 of each finger 62 is shaped to closely receive the rib 34 of each co-aligned finger 54 therein. Specifically, each finger 62 is provided with a collar 66 that is received within a groove 55 of each finger 54 that extends laterally across each finger 54, a shoulder 68 shaped to closely receive each rib 34 therein, and an outwardly-extending flange 70 including an outwardly-turned lip 72. Each finger 62 extends upwardly from an end wall 74. A plurality of apertures 76 are centrally located within each of the fingers 62 and continue into the associated end wall 74. Each of the apertures 76 closely receives a tab 57 of an associated finger 54 therein when assembled, so as to prevent rotational movement of the sleeve 20 within the associated extension 26.

In assembly, the locking ring 18 is aligned with the cover member 16 such that each extension 52 of the locking ring 18 is aligned with the locking arrangements 44 of the cover member 16. The locking ring 18 and cover member 16 are pressed together so as to cause the locking fingers 46 of each locking arrangement 44 to flex outwardly as the locking tabs 50 ride over the tabs 60, thereby securing the locking ring 18 with the cover member 16. The sleeves 20 are then inserted into the extension 52 such that the fingers 62 of each sleeve 20 are aligned with the fingers 54 of the associated extension 52, and further such that the apertures 76 of each sleeve 20 is aligned with the tabs 57 of the associated extension 52. The sleeves 20 and the extensions 52 are pressed together such that the tab 58 of each extension 52 is snap-fittingly received within the shoulders 68 of each sleeve 20. As best illustrated in FIG. 6, the wheel cover assembly 14 is assembled with the vehicle wheel 12 by aligning the extensions 52 and sleeves with the lug bolts 78 and lug nuts 80 as associated with the wheel 12. The wheel cover assembly 14 is then pressed inwardly in a direction 82 towards the wheel 12, thereby causing the fingers 54 of the extensions 52 to flex outwardly as the expanded head portion 84 of each lug nut 80 is received between the fingers 54, until the shoulder 68 of each sleeve 20 abuts a shoulder 86 of each lug nut 80, thereby securing the wheel cover assembly 14 with the vehicle wheel 12.

In operation, heat generated within the wheel 12 due to vehicle operation, such as braking, is received by the plurality of sleeves 20 rather then directly by the wheel clad assembly 15, thereby acting as a heat sink and reducing heat induced fatigue to the wheel clad assembly 15. The relatively large surface area of the end wall 74 allows heat as received by the sleeve 20 from the vehicle wheel 12 to quickly dissipate from within the sleeve 20, thereby further reducing the heat induced fatigue to the wheel clad assembly 15. The sleeves 20 further protect the wheel clad assembly 15 from wear by providing a relatively wear resistant surface in direct contact with the lug nuts 78 of the vehicle wheel 12 during disassembly and reassembly of the wheel cover assembly 14 with the vehicle wheel 12 as necessitated by vehicle maintenance and repair.

The present inventive connector and associated wheel assembly provides a more durable and heat resistant wheel covering that may be operated/installed by even unskilled personnel, can be easily and quickly assembled, is economical to manufacture, capable of a long operating life while installed on an associated vehicle wheel, and is particularly well adapted for the proposed use. Moreover, the wheel cover assembly is significantly resistant to heat induced fatigue, thereby reducing the chances of structural failure as well as degradation to the associated aesthetic covering.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A wheel cover assembly, comprising:
a wheel clad assembly, comprising:
a body member having an outer surface and an inner surface opposed across the body member from the outer surface; and
at least one elongated tubularly-shaped extension comprising a first material and having an inner surface, a proximal portion connected to the body member, a distal portion extending in a direction away from the inner surface of the body member, and at least one irregularity spaced along a length of the distal portion of the at least one extension; and
at least one tubularly-shaped insulating sleeve comprising a second material different from the first material and having an outer surface that abuts the inner surface of the at least one extension and includes an edge portion that closely receives the irregularity of the distal portion of the at least one extension therein, thereby preventing removal of the at least one sleeve from within the at least one extension in an axial direction;
wherein the edge portion is adapted to engage a vehicle wheel, thereby assembling the wheel cover assembly with the vehicle wheel, and wherein the sleeve is adapted to thermally insulate the wheel clad assembly from the vehicle wheel.

2. The wheel cover assembly of claim 1, wherein the at least one sleeve comprises stainless steel.

3. The wheel cover assembly of claim 2, wherein the at least one irregularity includes a circumferentially extending rib.

4. The wheel cover assembly of claim 3, wherein the distal portion of the at least one extension is divided into a plurality of longitudinally extending flexibly resilient fingers.

5. The wheel cover assembly of claim 4, wherein the at least one sleeve includes a plurality of longitudinally extending flexibly resilient fingers that are aligned with the fingers of the distal portion of the at least one extension.

6. The wheel cover assembly of claim 5, wherein the at least one extension includes at least one tab integrally formed and extending inwardly from the inner surface of the at least one extension, and wherein the at least one insulating sleeve includes at least one aperture closely receiving the tab of the at least one extension therein, thereby preventing rotational movement of the at least one sleeve with respect to the at least one extension.

7. The wheel cover assembly of claim 6, wherein the at least one sleeve includes an end wall.

8. The wheel cover assembly of claim 7, wherein the at least one extension member includes a plurality of extension members spaced circumferentially about the body member, and wherein the at least one sleeve includes a plurality of sleeve received within the plurality of extension members.

9. The wheel cover assembly of claim 1, wherein the edge portion of the at least one sleeve is adapted to releasably engage the wheel.

10. The wheel cover assembly of claim 9, wherein the edge portion of the at least one sleeve is adapted to snappably engage the wheel.

11. The wheel cover assembly of claim 9, wherein the edge portion of the at least one sleeve is adapted to snappably engage a lug nut of the wheel.

12. The wheel cover assembly of claim 1, wherein the at least one extension is substantially cylindrically shaped.

13. The wheel cover assembly of claim 1, wherein the at least one irregularity includes a circumferentially extending rib.

14. The wheel cover assembly of claim 1, wherein the distal portion of the at least one extension is divided into a plurality of longitudinally extending flexibly resilient fingers.

15. The wheel cover assembly of claim 14, wherein the at least one sleeve includes a plurality of longitudinally extending flexibly resilient fingers that are aligned with the fingers of the distal portion of the at least one extension.

16. The wheel cover assembly of claim 1, wherein the at least one extension includes at least one tab integrally formed and extending inwardly from the inner surface of the at least one extension, and wherein the at least one insulating sleeve includes at least one aperture closely receiving the tab of the at least one extension therein, thereby preventing rotational movement of the at least one sleeve with respect to the at least one extension.

17. The wheel cover assembly of claim 1, wherein the at least one sleeve includes an end wall.

18. The wheel cover assembly of claim 1, wherein the at least one extension member includes a plurality of extension members spaced circumferentially about the body member and wherein the at least one sleeve includes a plurality of sleeves received within the plurality of extension members.

19. A sleeve connector for connecting a wheel cover assembly to a vehicle wheel, comprising:
a tubularly-shaped body portion;
an outer surface adapted to abut an inner surface of a tubularly-shaped extension of a wheel covering; and
a plurality of longitudinally extending flexibly resilient fingers, each finger including an edge portion adapted to closely receive an irregularity located along a length of the extension of the wheel covering, thereby preventing removal of the sleeve from within the at least one extension in an axial direction;
wherein the edge portion is adapted to engage a vehicle wheel, thereby assembling the wheel covering with the vehicle wheel, and wherein the sleeve is adapted to thermally insulate the wheel covering from the vehicle wheel.

20. The sleeve connector of claim 19, wherein the body portion and the fingers comprise stainless steel.

21. The sleeve connector of claim 20, wherein the edge portion extends circumferentially about the sleeve.

22. The sleeve cover assembly of claim 21, wherein the edge portion is adapted to releasably engage the vehicle wheel.

23. The sleeve cover assembly of claim 22, wherein the edge portion is adapted to snappably engage a lug nut of the vehicle wheel.

24. The sleeve cover assembly of claim 22, wherein the edge portion is adapted to snappably engage the vehicle wheel.

25. The sleeve cover assembly of claim 24, further including:
at least one aperture adapted to closely receive a tab extending inwardly from the extension of the wheel covering, thereby preventing rotational movement of the sleeve with respect to the extension.

26. The sleeve cover assembly of claim 25, further including:
an end wall.

27. The sleeve connector of claim 19, wherein the body portion is substantially cylindrically shaped.

28. The sleeve connector of claim 19, wherein the edge portion extends circumferentially about the sleeve.

29. The sleeve cover assembly of claim 28, wherein the edge portion is adapted to releasably engage the vehicle wheel.

30. The sleeve cover assembly of claim 29, wherein the edge portion is adapted to snappably engage the vehicle wheel.

31. The sleeve cover assembly of claim 29, wherein the edge portion is adapted to snappably engage a lug nut of the vehicle wheel.

32. The sleeve cover assembly of claim 19, further including:
at least one aperture adapted to closely receive a tab extending inwardly from the extension of the wheel covering, thereby preventing rotational movement of the sleeve with respect to the extension.

33. The sleeve cover assembly of claim 19, wherein the at least one sleeve includes an end wall.
